(19) United States
(12) Patent Application Publication
(10) Pub. No.: US 2003/0084042 A1
(43) Pub. Date: May 1, 2003

(54) Evaluating potential for success in sports based on comparisons between genomic sequences

(76) Inventor: Gene M. Garner II, Germantown, MD (US)

Correspondence Address: STAAS & HALSEY LLP, 700 11TH STREET, NW, SUITE 500, WASHINGTON, DC, 20001, US

(21) Appl. No.: 09/985,094

(22) Filed: Nov. 1, 2001

(51) Int. Cl. G06F 17/30

(52) U.S. Cl. 707/5

(57) ABSTRACT

A computer system determines a correlation score and a ranking of prospects in sports based upon comparisons of genomic sequences of the prospects to evaluate potential for success in sports. The computer system includes a data base storing genomic sequences of prospects and a scoreboard, the scoreboard including rankings and correlation scores of prospects, and a data base populating module populating the data base by determining the rankings and correlations scores based upon correlation between genomic sequences of current prospects with genomic sequences of prior prospects.

### BACKGROUND OF THE INVENTION

1. Field of the Invention

The present invention is directed to comparing genomic sequences to evaluate potential for success in sports, and, more particularly, to comparing genomic sequences of current prospects to genomic sequences of prior prospects to evaluate potential for success in sports.

2. Description of the Related Art

Genetic (or genomic) sequences of genomes of individuals have been determined, including the sequence of the human genome and the genomes of animals. Between individuals, these sequences of bases (or stretches of DNA) vary at corresponding locations of the genome.

Using computers (and data bases) to determine the genomic (or genetic) sequences of individuals, and the similarities and variations between them, is known in the art, as is determining common genomic sequences between individuals.

An example of a sequence/gene data base which compares genomic sequences is BLAST (Basic Local Alignment Search Tool) from the National Center for Biotechnology Information (NCBI) at the U.S. National Institutes of Health.

Devices which extract from DNA (de-oxyribonucleic acid) and/or RNA (ribonucleic acid) the genomic sequences encoded therein are also known in the art. Genotyping using commercial products is also known in the art, as is integrated genome sampling, detection, and data processing using products by various manufacturers. Collecting of genomic information using, for example, GeneChip® by Affymetrix, Inc. is known in the art. Companies acting as content-providers of bioinformatic information are known in the art.

That is, extracting genomic sequences and comparing genomic sequences to determine similarities and differences between them is known in the art.

In sports, typical evaluations and characterizations of individuals are based upon observations and measurements involving characteristics and traits, the phenotype, of the individual, and, at times, pedigree, ancestry and historical data about the individual.

A prospect (an individual attempting to meet the requirements for competing at a desired level in sports and earn the opportunity to compete at that level) is typically evaluated by observing the current skills and characteristics, or the phenotype, of the prospect. That is, depending upon the sport, a prospect is typically evaluated by measuring how fast the prospect can run, how much weight the prospect can lift, how far the prospect can throw or kick a ball, the prospect's height and weight, the stride of the prospect, and other forms of observations and measurements of the prospect.

Whether an organization, such as a professional sports team or a high-level amateur sports team, will allocate a spot on a roster for the prospect, or allow the individual to compete through that organization, depends upon the evaluation of the prospect by the organization. This evaluation is based upon the above-mentioned observations and measurements, and other, similar observations and measurements. Based upon the evaluation, an educated guess is then ventured as to whether one prospect would make a larger contribution to the organization than another prospect, and, therefore, should be placed on the roster of the team over the other prospect.

Computer-based marketplaces (referred to as e-marketplaces), generally, are known in the art, as are marketplaces oriented to sports. Computer software related to establishing and conducting e-marketplaces is known in the art. Moreover, scouting organizations provide information about prospects to which sports teams may subscribe.

Also known in the art is testing, refinement, and demonstration of computer software using a single customer site, and the use of incentives for the customer to participate. The use of customer sites for prototyping of software, including installation of pilot software, is known in the art, as is the use of a customer site as a reference account. In addition, proof of concept and proof of product demonstrations are known in the art.

A problem is that the above-mentioned evaluation of the related art is based upon the current skills and characteristics of an individual, such as the prospect, without providing an objective analysis of whether skills and characteristics of the individual are likely to be enhanced with training of the individual.

Another problem of the related art is that an individual whose skills and characteristics are likely to be enhanced with training may be overlooked by the organization.

Yet a further problem of the related art is that an individual may not recognize that with training the individual could be competitive in an endeavor even though the individual may not be competitive based upon current skills and characteristics.

### SUMMARY OF THE INVENTION

It is an aspect of the present invention to provide an apparatus, method, e-marketplace, and computer-readable medium comparing genomic sequences to evaluate potential for success in sports, and, more particularly, to comparing genomic sequences of current prospects to genomic sequences of prior prospects.

It is another aspect of the present invention to identify an individual and provide an objective analysis of whether skills and characteristics of the individual are likely to be enhanced with training, based upon comparisons between genomic sequences of current prospects and prior prospects.

A further aspect of the present invention is to provide information as to whether the individual can succeed at a sport different than the sport for which the individual is attempting to enter or continue, based upon comparisons of genomic sequences between the individual and prior prospects.

Another aspect of the present invention is to unlock the potential of the human genome to provide a measure by which the potential for success in sports is judged, based upon comparisons of genomic sequences between current prospects and prior prospects.

The present invention comprises an apparatus, method, e-marketplace, and computer-readable medium storing a program which when executed by a computer unlocks the potential of the human genome to provide a measure by which the potential for success in sports is judged, based upon comparisons of genomic sequences between current prospects and prior prospects.

These and other aspects of the present invention are accomplished by an apparatus, method, e-marketplace, and computer-readable medium comparing genomic sequences to evaluate potential for success in sports, and, more particularly, to comparing genomic sequences of current prospects to genomic sequences of prior prospects to evaluate potential for success in sports.

More particularly, the present invention comprises a computer system comparing genomic sequences of prospects to evaluate potential for success in sports of individuals. The computer system of the present invention comprises a data base storing genomic sequences of prospects and a scoreboard, the scoreboard including rankings and correlation scores of a current prospect based upon comparisons between the genomic sequences of the current prospect with the genomic sequences of prior prospects. The computer system of the present invention also comprises a data base populating module populating the data base by determining the correlation scores and the rankings based upon correlation between the genomic sequences of the current prospect with the genomic sequences of the prior prospects.

In addition, the present invention comprises a display of a computer system. The display of the present invention comprises names of current prospects grouped by sport and position, and ranks and correlation scores of the current prospects based upon correlation of genomic sequences of the current prospects with genomic sequences of prior prospects, the ranks and correlation scores indicating potential for success in sports of individuals.

Moreover, the present invention comprises a genomic sports profile e-marketplace matching individuals with sports teams, based upon rankings and correlation scores of the individuals based upon comparisons between genomic sequences. The genomic sports profile e-marketplace of the present invention comprises a computer system evaluating the potential for success in sports of the individuals. The computer system of the present invention is in communication with the individuals and sports teams and provides information to the sports teams based upon correlation scores and ranks of the individuals based upon correlations of genomic sequences of the individuals with genomic sequences of prior prospects.

Further, the present invention comprises a method of evaluating potential for success in sports of individuals. The method of the present invention comprises determining correlation scores of the individuals with prior prospects based upon correlation between genomic sequences of the individuals and genomic sequences of prior prospects, and ranking the individuals based on the correlation.

In addition, the present invention comprises a computer-readable medium storing a program which, when executed by a computer, causes the computer to evaluate potential for success in sports of individuals by executing the processes comprising determining correlation scores and rankings of the individuals by determining correlation between genomic sequences of the individuals and genomic sequences of prior prospects, and ranking the individuals based on the correlation.

A prospect, or current prospect, in sports is an individual attempting to continue in, or enter, a sport at a higher level than which the individual has been competing.

A prior prospect, in sports, is an individual who has participated in, or previously attempted to continue in, or enter, a sport at the level (or higher) for which the prospect is attempting to continue in or enter. Prior prospects, in sports, include individuals who have gained recognized success in sports at the indicated level, and are referred to as champions. Prior prospects, in sports, also include individuals who did not succeed in sports at that level, and are referred to as unsuccessful prospects.

Other endeavors, beyond sports, would also include prospects, current prospects, prior prospects, champions, and unsuccessful prospects defined by those endeavors.

In the present invention, a Genomic Sports Profile of an individual includes an individual's name and other identifying and contact information, correlation scores established by comparing the individual's genomic sequences with the genomic sequences of the prior prospects, and ranking information established with respect to other, current prospects.

Also in the present invention, genomic sequences and their locations common to prior prospects are identified (using techniques known in the art), the genomic sequences of the current prospects at the corresponding locations are compared to the genomic sequences of the prior prospects (also using techniques known in the art), and the correlations between the genomic sequences are determined by the present invention.

The present invention compares (using techniques known in the art) the genomic sequences of the current prospect with the genomic sequences of the champions (either individually or collectively) to determine (also using techniques known in the art) what common genomic sequences exist between the champions and whether and to what degree the current prospect also has similar genomic sequences.

The present invention also compares (using techniques known in the art) the genomic sequences of the current prospect with the genomic sequences of the unsuccessful prospects (either individually or collectively) to determine (also using techniques known in the art) what common genomic sequences exist between the unsuccessful prospects and whether and to what degree the current prospect also has similar genomic sequences.

Correlation scores for each of the above-mentioned comparisons, and an overall correlation score, are established for each current prospect based on the comparisons.

Moreover, the present invention compares the correlation scores of each current prospect with the correlation scores of the other current prospects to determine the potential of the current prospect for success in sports relative to the potential of the other, current prospects for success in sports and ranks each current prospect accordingly.

These and further aspects and advantages of the present invention which will become apparent are included in the above-mentioned summary of the invention and in the following detailed description, drawings, and claims of the present invention, in which like numerals refer to like parts in the accompanying drawings.

### BRIEF DESCRIPTION OF THE DRAWINGS

FIG. 1 is an overview 8 of the present invention.

FIG. 2 shows a Genomic Sports Profile computer system of the present invention.

FIG. 3 shows a detailed diagram of the Genomic Sports Profile module of the present invention.

FIG. 4 shows a flowchart of an example of establishing a correlation score by the Genomic Sports Profile module of the present invention.

FIG. 5 shows a detailed diagram of a Genomic Sports Profile data base populating module of the present invention.

FIG. 6 shows a flowchart of populating the Genomic Sports Profile data base/scoreboard of the present invention with genomic sequencing information extracted from prior prospects.

FIG. 7 shows a flowchart of populating the Genomic Sports Profile data base/scoreboard of the present invention with genomic sequencing information extracted from current prospects.

FIG. 8 shows an example of correlating the genomic sequence from a prospect P with the genomic sequence from champions C, in accordance with the present invention.

FIG. 9 shows the Genomic Sports Profile module evaluation results display module of the present invention.

FIG. 10 is a flowchart of displaying correlation scores, rankings of current prospects using the Genomic Sports Profile module evaluation results display module of the present invention.

FIG. 11 is a diagram of a Genomic Sports Profile display result of the Genomic Sports Profile module evaluation results display module of the present invention, displayed on a typical display device.

FIG. 12 shows an example of a Genomic Sports Profile e-marketplace 110 of the present invention.

### DESCRIPTION OF THE PREFERRED EMBODIMENTS

The present invention compiles a database of genomic information of prior prospects and correlates an individual's genomic information with that in the database, to determine how closely the individual matches.

The embodiment disclosed herein relates to sports and sports teams, but the present invention could include other endeavors. For example, if a company were to compile a database of genomic information about current and past major league baseball pitchers (both positive and negative information) and test genomic information from a pitching prospect against that database, the present invention would provide a correlation score to each prospect, and rank the prospects accordingly. This would allow teams to find prospects who are “sleepers” (that is, prospects who may not demonstrate major league ability but who have it “in their genes” and who must work more to develop it), and to eliminate prospects who have already “peaked” at the high school or minor league level.

Access to the database of the present invention would be useful to prospective employers (in the above example, professional-level teams or college teams, etc.) and to individuals interested in determining how closely they correlate genetically with the best to have participated in the sport.

The present invention includes an e-marketplace, referred to as Genomic Sports Profile e-marketplace, and a Genomic Sports Profile computer system comprising computer-executable software, referred to as Genomic Sports Profile module, and a data base, referred to as Genomic Sports Profile data base/scoreboard. The Genomic Sports Profile computer system of the present invention, which enables the Genomic Sports Profile e-marketplace of the present invention, comprises the Genomic Sports Profile module of the present invention and the Genomic Sports Profile data base/scoreboard of the present invention.

Overview of the Present Invention

The present invention establishes respective databases of genomic sequences obtained from individuals who are recognized champions and unsuccessful prospects in professional baseball, professional football, professional basketball, professional hockey, tennis, golf, swimming, college teams, college sports, amateur sports, high-level amateur teams, racing, track & field, and other sports and levels of sports. These databases, which apply to individuals who are humans, animals, birds, fish, etc., are organized according to sport and by position within the sport.

Genomic sequences (and their respective locations in the genome) common to champions of a particular position in a particular sport are identified by the Genomic Sports Profile module of the present invention, using techniques known in the art. Moreover, genomic sequences common to unsuccessful prospects (those who were not allocated a roster spot or those who were allocated a roster spot but were subsequently injured or released) are also identified by the Genomic Sports Profile module of the present invention, also using techniques known in the art.

The present invention assigns weights by the Genomic Sports Profile module of the present invention to each of the identified genomic sequences based upon criteria such as how closely the identified genomic sequences correlate to individuals recognized as champions or as unsuccessful prospects. For example, if it is found that a particular genomic sequence appears at a particular location in all of the champions, but none of the unsuccessful prospects, then a very high weight (such as “10”) may be assigned to that genomic sequence. However, if that particular genomic sequence appears in half of the champions, but not in the other half of the champions, then a lower weight (such as “5”) may be assigned to that genomic sequence.

Genomic sequences obtained from prospective champions are then correlated by the Genomic Sports Profile module of the present invention to the identified genomic sequences of the champions and the unsuccessful prospects.

The present invention assigns a correlation score by the Genomic Sports Profile module of the present invention to each prospect, indicating how closely the prospect correlates to the champions and to the unsuccessful prospects. The Genomic Sports Profiles are stored in the Genomic Sports Profile data base/scoreboard by the Genomic Sports Profile module for future access by the Genomic Sports Profile module. The genomic sequence information is stored in the Genomic Sports Profile data base/scoreboard, and the correlation scores (also stored in the Genomic Sports Profile data base/scoreboard) of all of the prospects evaluated by the Genomic Sports Profile module forms the scoreboard.

This correlation score is then used by sports teams by accessing the Genomic Sports Profile module to identify prospects whose talents may not have expressed themselves during evaluations, but correlate closely with established champions.

The Genomic Sports Profile e-marketplace of the present invention then makes available to individuals and sports teams the information extracted and correlated by the Genomic Sports Profile module 14 of the present invention.

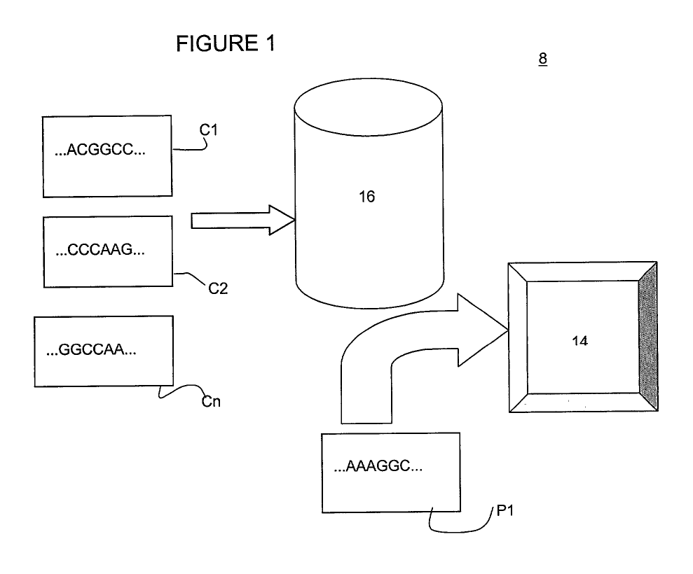

FIG. 1 is an overview 8 of the present invention. As shown in FIG. 1, the present invention establishes a Genomic Sports Profile data base/scoreboard 16 of genomic information from established champions of sport (C1, C2, . . . , Cn), using techniques known in the art. One example of an implementation of the Genomic Sports Profile data base/scoreboard 16 would be on a known computer system platform (such as available from COMPAQ COMPUTER CORPORATION) using a known relational data base (such as available from ORACLE CORPORATION) implemented in, for example, a Storage Network Array (SNA). This implementation would allow remote access to the Genomic Sports Profile data base/scoreboard 16 through a World Wide Web (WWW) interface using the Internet.

Use of a relational data base organized in an SNA provides flexibility of access to the stored data. Access to the Genomic Sports Profile data base/scoreboard 16 is password-protected through an established firewall, to safeguard the sensitive genomic information stored therein.

Once the Genomic Sports Profile data base/scoreboard 16 is established, the genomic information from each champion is correlated using techniques known in the art. Both positive correlations and negative correlations are instituted. The present invention correlates the genotype, and does not require correlation of the phenotype, from the genomic information of each champion. That is, the present invention determines, using known techniques, whether there is a particular genomic sequence at a particular genetic location common to most or all champions, independent of what protein that particular genomic sequence at that particular genetic location codes for. The present invention also determines, using known techniques, whether there is the absence of other particular genomic sequences from the champions, which may code for a protein which would have inhibited their becoming champions. This genomic information would be obtained from so-called “can't miss” prospects who were, in reality, unsuccessful prospects.

These genomic correlations are collected into a Genomic Sports Profile data base/scoreboard 16, which would also be implemented in a relational data base.

The genomic information collected from the prospect (P1) is correlated to the genomic information collected from the champions (C1, C2, . . . ,Cn) by the Genomic Sports Profile module 14 of the present invention and a score is established for the prospect by the Genomic Sports Profile module 14 of the present invention.

Genomic Sports Profile Computer System 10

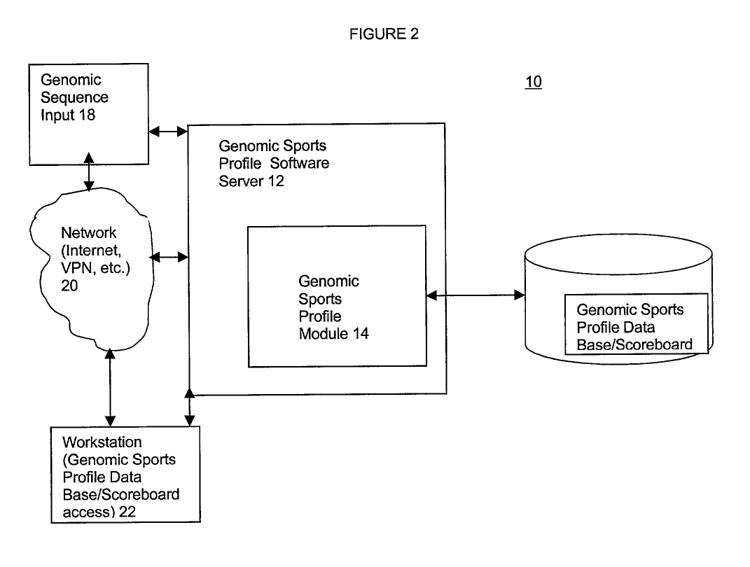

FIG. 2 shows a computer system 10 of the present invention, referred to as Genomic Sports Profile computer system 10. The architecture of the Genomic Sports Profile computer system10 of the present invention is not limited to that shown in FIG. 2. That is, the Genomic Sports Profile computer system 10 of the present invention could be a standalone computer system or an n-tier computer system executing Genomic Sports Profile module 14 and including the Genomic Sports Profile data base/scoreboard 16 of the present invention.

As shown in FIG. 2, Genomic Sports Profile computer system 10 is based upon a server 12 executing Genomic Sports Profile module 14, which accesses Genomic Sports Profile data base/scoreboard 16. An example of Genomic Sports Profile module 14 of the present invention is a software computer program executed by a computer, such as server 12.

Examples of computer systems upon which the computer server 12 executing the Genomic Sports Profile module 14 of the present invention could be implemented include computer systems from a variety of computer manufacturers.

Genomic sports profile module 14 reads in genomic sequences from Genomic Sequence Input 18 either directly or through network 20. Moreover, sequences can be imported to the Genomic Sports Profile data base/scoreboard 16 through other, conventional, means.

Once the genomic information is read into the Genomic Sports Profile module 14, the Genomic Sports Profile module 14 then extracts, using techniques known in the art, from the genomic sequence input through Genomic Sequence Input 18 the genomic sequences discussed herein above, and stores the extracted genomic sequences in the Genomic Sports Profile data base/scoreboard 16.

Referring again to FIG. 2, in the case in which the input genomic sequence corresponds to a champion, the Genomic Sports Profile module 14 compares, using techniques known in the art, the input genomic sequence to that of other champions and determines which particular genomic sequences are in common between the genomic sequences of the champions. These common genomic sequences, their respective locations on the genome, and the input genomic sequences are then stored in the Genomic Sports Profile data base/scoreboard 16.

Extracting genomic sequences and comparing the genomic sequences with each other to determine similarities (including common genomic sequences) and differences between them is known in the art. The present invention could also receive as input the results of conventional genomic sequence comparisons, their similarities, and differences.

In the case in which the input genomic sequence is from a prospect, Genomic Sports Profile module 14 determines a correlation score between the input genomic sequence and the genomic sequences of the champions by reading the common genomic sequences of the champions from the Genomic Sports Profile data base/scoreboard 16, and correlating the input genomic sequence with the common genomic sequences. The input genomic sequence, along with a correlation score assigned by the Genomic Sports Profile module 14 based upon how closely the input genomic sequence corresponds (or correlates) to the common genomic sequences, is stored in the Genomic Sports Profile data base/scoreboard 16.

Information is encoded (using, for example, PGP or PKI) when transmitted by the Genomic Sports Profile computer system 10 of the present invention, and may be decoded when received by users having the required keys.

Genomic Sports Profile Module

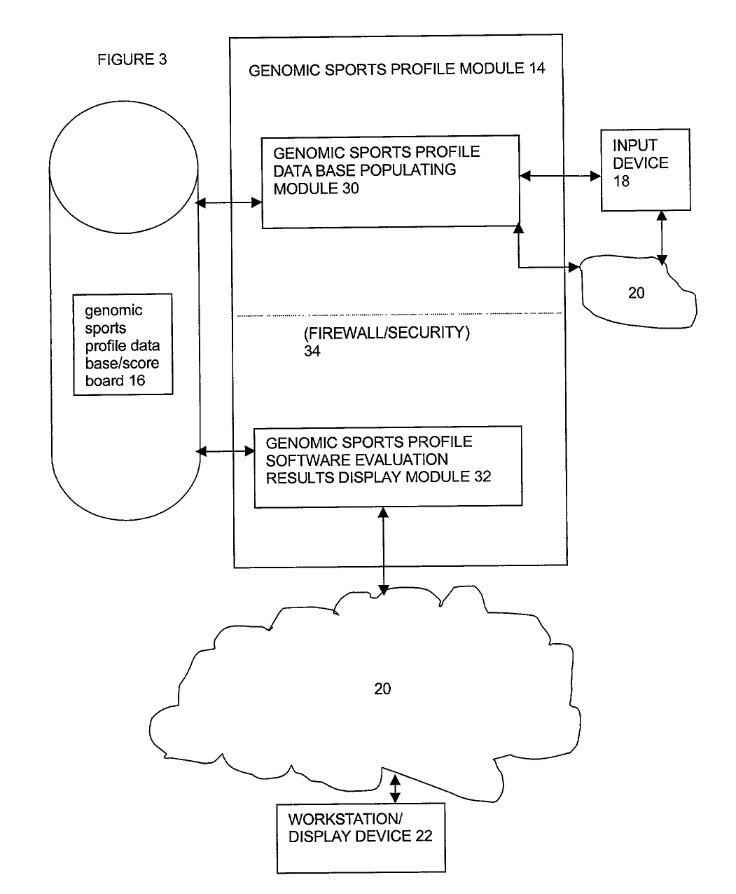

FIG. 3 shows a detailed diagram of the Genomic Sports Profile module 14 of the present invention. As shown in FIG. 3, Genomic Sports Profile module 14 of the present invention comprises a Genomic Sports Profile data base populating module 30 and a Genomic Sports Profile module evaluation results display module 32, separated from each other by a firewall (or other security measures) 34. Alternatively, each of the Genomic Sports Profile data base populating module 30 and a Genomic Sports Profile module evaluation results display module 32 could be implemented on separate computer systems, with secure access procedures.

Generally, the Genomic Sports Profile data base populating module 30 receives input of genomic sequences from input device 18, either directly or through network 20, and populates the Genomic Sports Profile data base/scoreboard 16. The Genomic Sports Profile module evaluation results display module 32 receives a request from workstation/display device 22, either directly or through network 20, to evaluate and display results from the evaluation of a prospect against champions, based upon the populated Genomic Sports Profile data base/scoreboard 16.

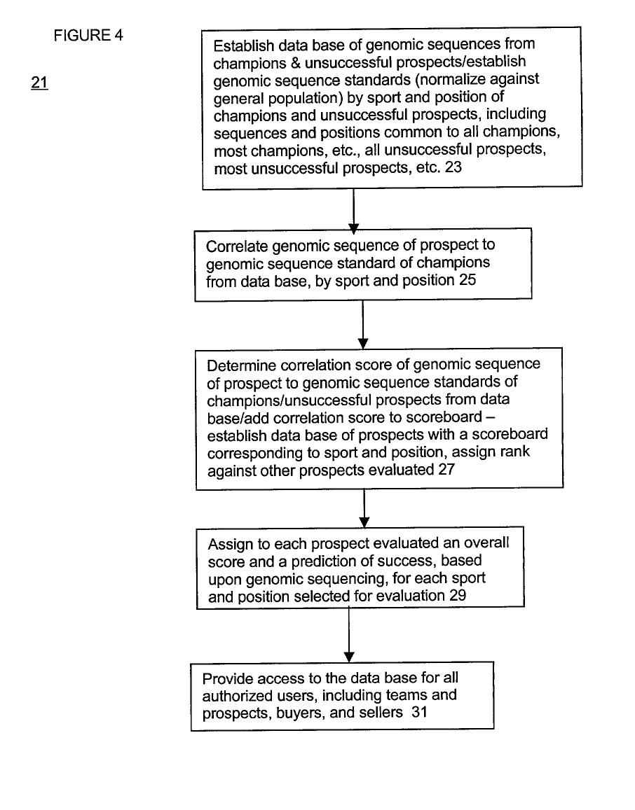

An example of establishing a correlation score by the Genomic Sports Profile module 14 is now presented with reference to the flowchart 21 of FIG. 4.

Referring now to FIG. 4, the Genomic Sports Profile data base 16 is established 23 as follows. The genomic sequence of each of the champions (that is, recognized champions) is analyzed to determine the genomic sequence included therein, using techniques known in the art. The genomic sequence of each champion analyzed could then be normalized (using techniques known in the art), perhaps using the genomic sequence created from a composite or representative sampling of people as sequenced, to remove genomic sequences common to all people. Then, the remaining genomic sequences of the champions are compared to each other, to determine what genomic sequences (and their respective locations in the genome) are common to each champion, also using techniques known in the art. Composite genomic sequences, reflective of those genomic sequences common to each of the champions, common to most of the champions, common to some of the champions, etc., are established in the Genomic Sports Profile data base/scoreboard 16.

Then, the genomic sequence from a prospect is normalized using the same genomic sequence of the mixture or sampling of people, and the remaining genomic sequence (and location in the genome) is compared, using techniques known in the art, to the common genomic sequence of the champions, or to the composite genomic sequences of the champions.

A correlation score is developed by, for example, assigning a numerical value to each sequence at each location which the prospect has in common with the common genomic sequence of the champions 25, 27, and totaling the values for the prospect. In addition, weighted ranks for the prospects may be established by comparing the genomic sequence of the prospect to the above-mentioned composite genomic sequences of the champions.

If there is a genomic sequence determined to be common to all prior prospects who have tried and failed to become successful, but is not common to the champions, then a numerical value (such as a negative number) is assigned to a prospect if the prospect also includes that genomic sequence.

Moreover, weights which increase or decrease the relative importance of having a corresponding genomic sequence at a location or series of locations could be assigned. The total of the values is then determined to be the correlation score for the prospect 29.

Once the Genomic Sports Profile data base/scoreboard 16 of the present invention is established, access to the Genomic Sports Profile data base/scoreboard 16 of the present invention is provided by the Genomic Sports Profile computer system 10 of the present invention to each authorized user, including sports teams, prospects, buyers, and sellers, of the genomic information and correlations 31.

The Genomic Sports Profile data base/scoreboard 16 of the present invention is organized by category of champion.

Moreover, the Genomic Sports Profile module 14 of the present invention and the Genomic Sports Profile data base/scoreboard 16 of the present invention are stored on a computer-readable medium, such as a disk, diskette, CD-ROM, other memory, etc

Genomic Sports Profile Data Base/scoreboard 16

The Genomic Sports Profile data base/scoreboard 16 of the present invention includes: (1) establishing the data base/scoreboard 16, and (2) accessing the data base/scoreboard.

Establishing the Data Base/scoreboard 16

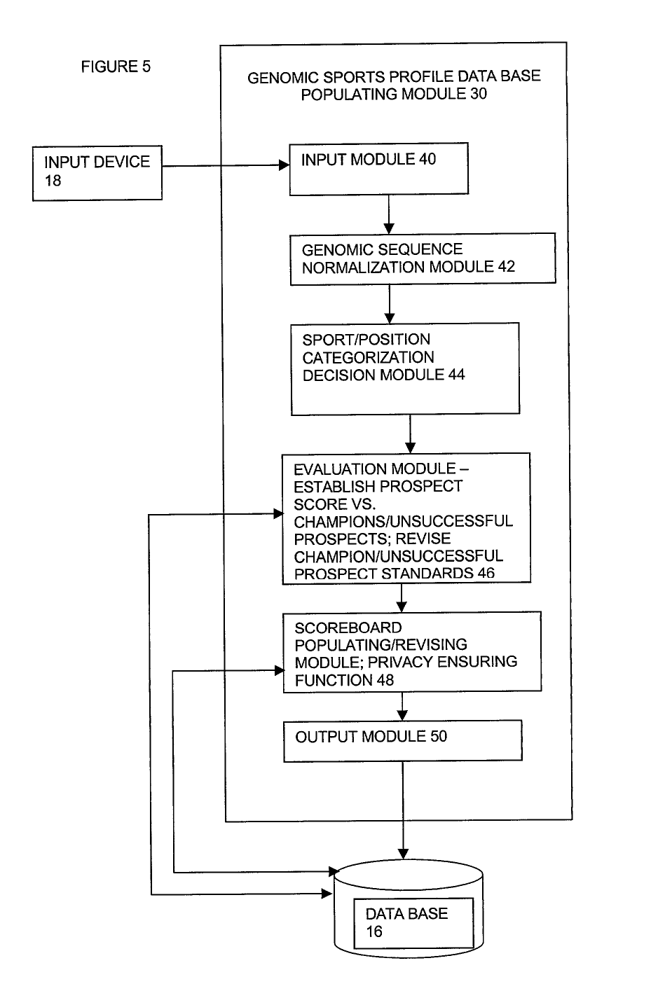

FIG. 5 shows a detailed diagram of Genomic Sports Profile data base populating module 30 of the present invention. As shown in FIG. 5, an input device 18 inputs, using conventional techniques, a genomic sequence (either from a champion or a prospect) to the input module 40 of the present invention. In one embodiment of the present invention, the input module 40 then transmits the genomic sequence to the genomic sequence normalization module 42 of the present invention, for normalization, although normalization is not required.

Alternatively, the genomic sequence normalization module 42 of the present invention may receive results of comparisons between genomic sequences carried out by conventional techniques.

Once normalized, the genomic sequence is then transmitted to the sport/position categorization decision module 44 for categorizing the prospect or the champion.

Normalization, though, is not required in the present invention. Each genomic sequence may be compared directly against other genomic sequences.

Next, the genomic sequence is transmitted to the evaluation module 46 of the present invention. If the input genomic sequence was one of a prospect, the evaluation module 46 establishes for the prospect a score based upon comparison of the prospect's genomic sequence with those of the champions/unsuccessful prospects established in the Genomic Sports Profile data base 16 of the present invention.

On the other hand, if the input genomic sequence is that of a champion or unsuccessful prospect, then the champion or unsuccessful prospect standards stored in the Genomic Sports Profile data base 16 of the present invention are revised based on the input genomic sequence.

Next, based upon either the score of the prospect or the revised standards of the champion/unsuccessful prospect, the scoreboard of the present invention stored in the Genomic Sports Profile data base 16 of the present invention is revised by Scoreboard Populating/Revising Module 48 of the present invention. In that regard, a privacy ensuring function (that is, password-protecting access and encoding information transfer) is implemented by the Scoreboard Populating/Revising Module 48 of the present invention.

Then, the genomic sequence, and either the score of the prospect or the revised standards of the champion/unsuccessful prospect are output to and stored in the Genomic Sports Profile Data Base 16 of the present invention.

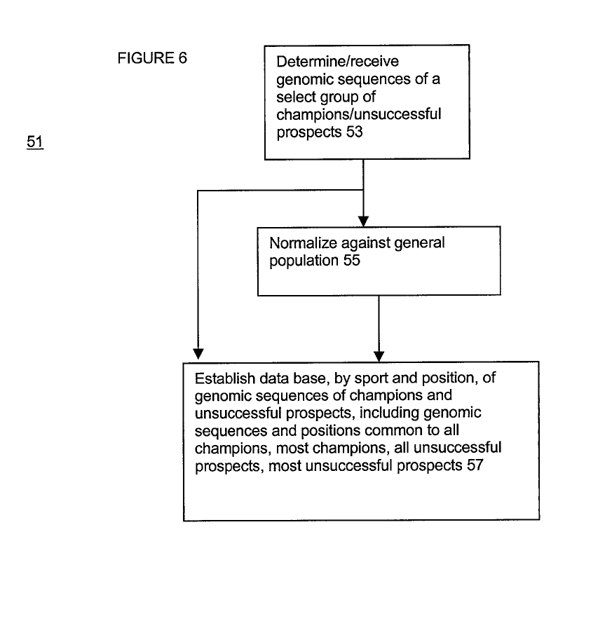

FIG. 6 shows a flowchart 51 of populating the Genomic Sports Profile data base/scoreboard 16 of the present invention with genomic sequencing information extracted from prior prospects.

The genetic sequences of a select group of champions/unsuccessful prospects is determined 53. The genetic sequences determined in 53 are normalized 55 against the general population. Then, the Genomic Sports Profile Data Base 16 is established 57 for use in evaluation of the prospect.

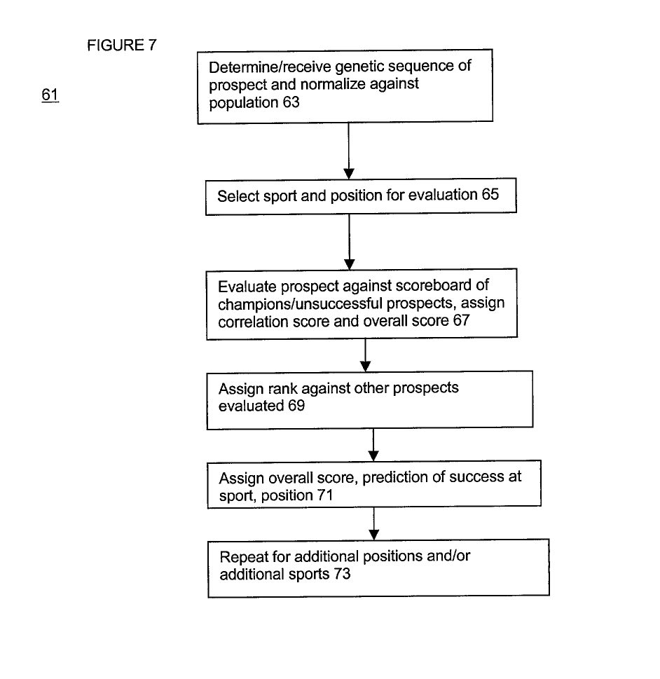

FIG. 7 shows a flowchart 61 of populating the Genomic Sports Profile data base/scoreboard 16 of the present invention with genomic sequencing information extracted from current prospects.

Referring now to the flowchart 61 of FIG. 7, the genetic (or genomic) sequence of the prospect is determined (conventionally) and normalized against the population 63. Then, the sport/position is selected for evaluation 65. Next, the prospect is evaluated against the Genomic Sports Profile data base/scoreboard 16 of champions/unsuccessful prospects, and a correlation score is assigned 67 to the prospect 71.

The prospect is assigned a rank against the other prospects evaluated, based upon the respective correlation scores of the other prospects being evaluated 69.

Then, an overall score and a prediction of success, based upon the correlation score and the rank, is assigned to the prospect 71.

The above-mentioned processes 63-71 are repeated for additional positions for which the current prospect is being evaluated and for additional sports for which the current prospect is being evaluated 73.

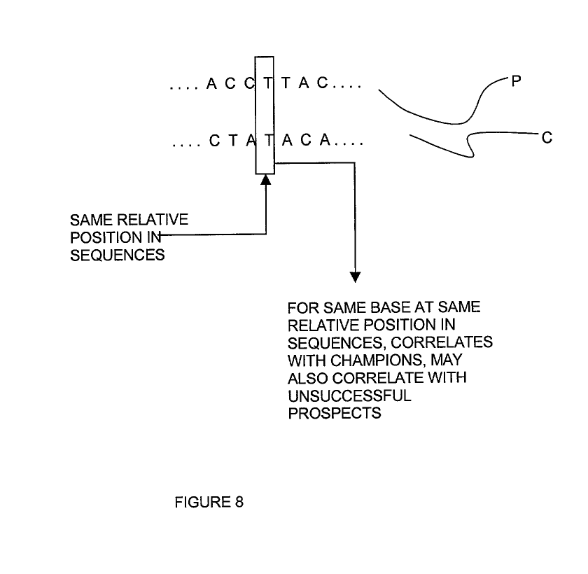

FIG. 8 shows an example of correlating the genomic sequence from a prospect P with the genomic sequence from champions C, in accordance with the present invention. The genomic sequence may include one or more nucleotides (or bases) which correlate. That is, the genomic sequences being compared with each other may have only one nucleotide (or base) that is the same at the same location.

To determine the correlation score between P and C, determine the total number of amino acids (or bases) that P and C have in common at the same locations (using techniques known in the art). If an amino acid (or base) in a particular location is more common to the champions, then apply a weight to that location such that the correlation score increases. In addition, a correlation score between the prospect P and the unsuccessful prospects can be determined in the same way. Further, weights can be assigned to each of the scores if encoding with a particular value at a particular location is relatively more or less important than encoding otherwise. Moreover, a total correlation score can be determined based upon the difference between the correlation score with the champions and the correlation score with the unsuccessful prospects (subtracting the latter from the former).

The correlation scores of the prospects are then accessed through the Genomic Sports Profile module 14 either by workstation (personal computer, etc.) 22 through network or directly by through server 12.

Establishing correlation scores in this way also accounts for any non-linear types of genetic coding which may occur.

In addition, the correlation of genomic information would be implemented by algorithms in software, and would take into account technologies from statistics, computer science, and biology. Moreover, the present invention includes a graphical user interface (GUI), which permits easy access to the Genomic Sports Profile data base/scoreboard 16 to authorized users.

Next, the Genomic Sports Profile Module Evaluation Results Display Module 32 of the present invention is explained.

The current prospect is scored against the champions and against the unsuccessful prospects separately because the current prospect may score very high against the champions, but exhibit a genotype associated with a common (but possible preventable) undesirable phenotype of unsuccessful prospects (for example, a propensity to encounter knee injuries).

Accessing the Data Base/scoreboard 16

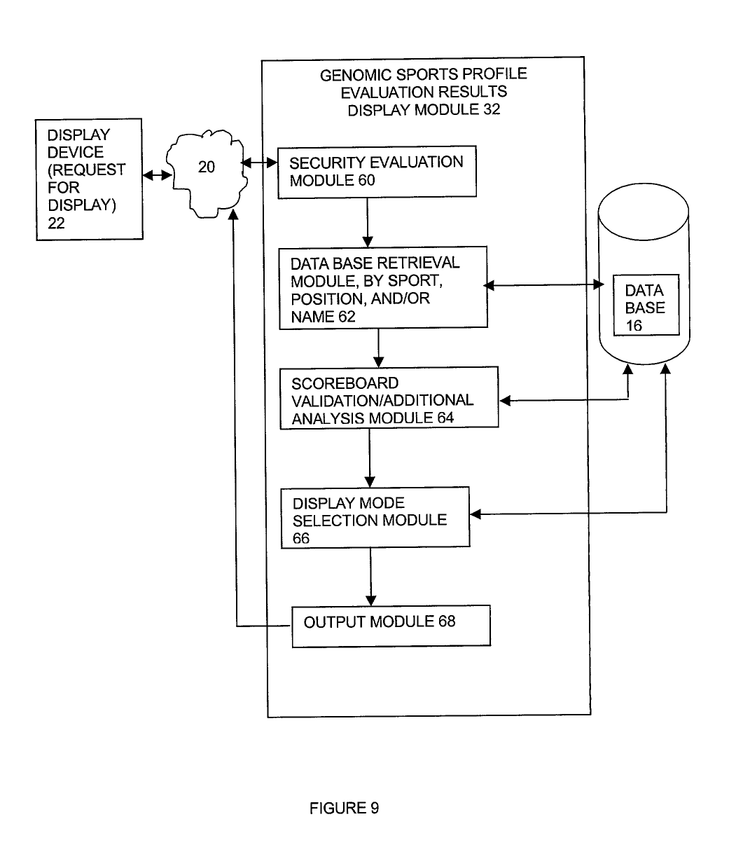

FIG. 9 shows the Genomic Sports Profile Evaluation Results Display Module 32 of the present invention, which includes a Security Evaluation Module 60 which receives a request from a display device 22 to display the score of a prospect stored in the Genomic Sports Profile Data Base 16. The Security Evaluation Module determines whether acceptable login/password combinations, along with other security information, is presented. If so, then the Data Base Retrieval Module 62 of the present invention access the Genomic Sports Profile Data Base 16 to retrieve a prospects score, either by sport (relative to other prospects in the sport), by position (relative to other prospects at that position) or by name (relative to other prospects, generally).

If there has been a revision to the champion/unsuccessful prospect standards, or if there have been scores for additional prospects added, then the Scoreboard Validation/Additional Analysis Module 64 re-establishes the score of the prospect.

Once the score of the prospect has been established/re-established, then the Display Mode Selection Module 66 of the present invention displays the scores of the prospects in the modes requested by the user through the display device 22.

The Output Module 68 of the present invention then outputs the data in the format requested through the display device 22.

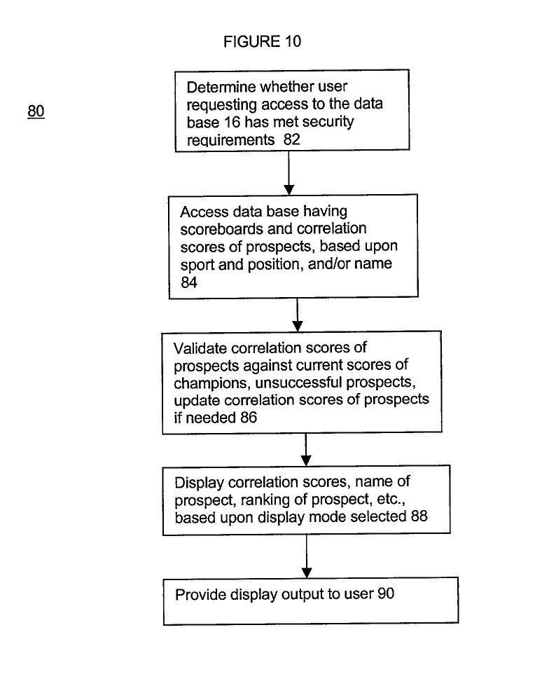

FIG. 10 is a flowchart 80 of displaying correlation scores, rankings of current prospects using the Genomic Sports Profile module Evaluation Results Display Module of the present invention.

Referring now to FIG. 10, the Genomic Sports Profile module Evaluation Results Display Module 32 of the present invention receives from a user 22 a request to display the names of prospects, the rankings of the prospects, the correlation scores of the prospect, the relative ranking of the prospects, etc.

The Security Evaluation Module 60 of the present invention determines whether user requesting access to the Genomic Sports Profile data base/scoreboard 16 of the present invention has met security requirements 82, including supplying the correct user identification (ID) and password. These security requirements are customizable and are established by the Genomic Sports Profile e-marketplace 110 of the present invention (as disclosed herein below).

If the required security requirements are met, the Data Base Retrieval Module 62 accesses the Genomic Sports Profile data base/scoreboard 16 having scoreboards and correlation scores of prospects, based upon sport and position, and/or name 84, supplied by the user 22. If not, an error message is returned.

Next, the Scoreboard Validation/Additional Analysis Module 64 of the present invention validates correlation scores of prospects against current scores of champions, unsuccessful prospects, update correlation scores of prospects if needed 86.

Thereafter, the Display Mode Selection Module 66 of the present invention displays correlation scores, name of prospect, ranking of prospect, etc., based upon display mode selected 88.

The Output Module 68 of the present invention provides 90 display output to user 22 and interfaces with the display devices 22 making the request for display.

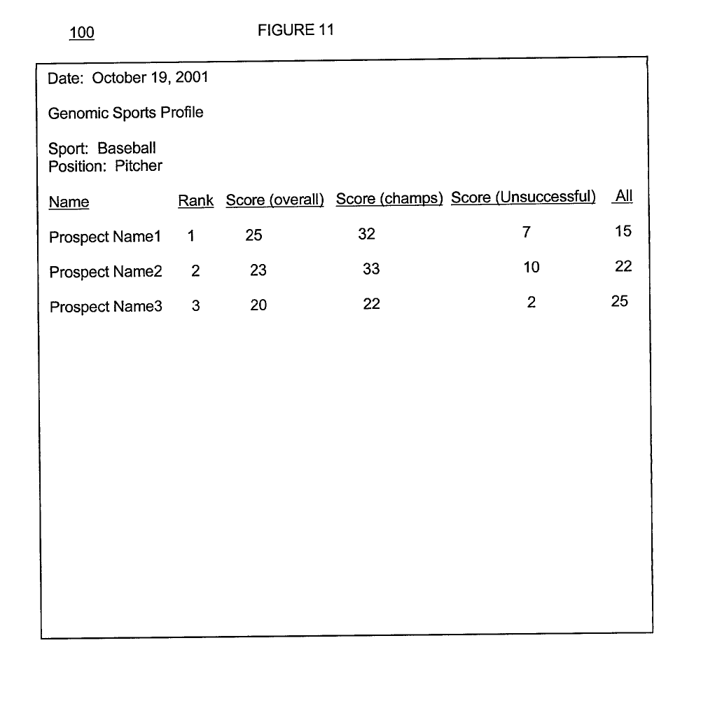

FIG. 11 is a diagram of a display 100 of results of the Genomic Sports Profile module Evaluation Results Display Module 32 of the present invention, displayed on a typical display device. Referring now to FIG. 11, 3 baseball pitcher prospects are evaluated and ranked 1, 2, and 3. The ranking is established by the Genomic Sports Profile computer system 10 of the present invention based upon an overall correlation score, which comprises a correlation score with the champions minus a correlation score with the unsuccessful prospects. In the example of FIG. 11, Prospect Name1 has a higher overall score than does Prospect Name2, despite having a lower correlation score with the champions than Prospect Name2. Prospect Name1 is ranked higher than Prospect Name2 because Prospect Name1 has a lower correlation score with the unsuccessful prospects than does Prospect Name2. In the example of FIG. 11, the overall correlation score is determined for each current prospect (Prospect Name1, Prospect Name2, Prospect Name3) by subtracting the correlation score with the unsuccessful prospect from the correlation score with the champions. In addition, a rank of each current prospect with all current baseball prospects is provided, regardless of position. Thus, a team may determine to select the highest-ranked prospect, despite position.

The criteria used to determine the rank of the prospects is customizable.

Moreover, access to the genomic sports profile data base/scoreboard 16 can be granted to sports teams by payment of a yearly fee by the sports teams, and to current prospects by payment of a one-time fee to be included in the genomic sports profile data base/scoreboard 16.

Genomic Sports Profile e-marketplace

Moreover, the present invention comprises genomic sports profile e-marketplaces (customizable for business-to-business (B2B) transactions with sports teams or business-to-consumer (B2C) transactions with prospects) for genomic information, rankings, and correlation scores organized by categories such as sport and position within the sport, age, etc.

The genomic sports profile e-marketplace of the present invention provides a medium, such as a computer network, by which users such as sports teams, sports agents, prospects themselves, sponsoring organizations of the individual, prospective buyers of the skills of the individual, etc. may access the rankings, and correlation scores stored in the Genomic Sports Profile data base/scoreboard 16, perhaps for a yearly fee. These users are paired with the prospects having correlation scores and rankings stored in the Genomic Sports Profile data base/scoreboard 16. In addition, sponsoring organizations, owners/employers of the individual (owners when the individual is an animal), etc. may participate in the Genomic Sports Profile data base/scoreboard 16 access.

The genomic sports profile e-marketplace of the present invention involves prospects desiring to advance from one level of sports to the next, and candidates (such as free agents) competing at one level of sports who want to change teams or compete on a different circuit within that same level of sports.

Through the computer network that is the medium of the genomic sports profile e-marketplace of the present invention, access is obtained through computer terminals coupled to a central server which includes the Genomic Sports Profile module 14 and the Genomic Sports Profile data base/scoreboard 16 of the present invention.

In exchange for the ability to access the genomic information, users would be charged a yearly access. This yearly access fee would entitle the users to access password-protected Genomic Sports Profile data base/scoreboard 16, either remotely or through dedicated access devices, and would also entitle the users to access any updates to the Genomic Sports Profile data base/scoreboard 16 during the year of access. At the end of the year for which access has been granted, access may be renewed by the user by payment of additional access fees.

The Genomic Sports Profile data base/scoreboard 16 of the present invention would be updated at least yearly, to provide for genomic information of current champions, which takes into account trends in what is considered to be a champion. That is, skills of champions of a prior era may not qualify that prior-era champion as a current champion of sports.

In addition, prospects may be included in the Genomic Sports Profile data base/scoreboard 16 by payment of a one-time fee. The one-time fee would include access by the prospects to the genomic information in the Genomic Sports Profile data base/scoreboard 16 related to the prospect, and access to ranking information about the prospect based on sport and position. The prospect may also be granted access to which teams have made inquiry about the prospect, to determine the level of interest of the prospect in those teams. That is, the present invention would also match prospects with teams.

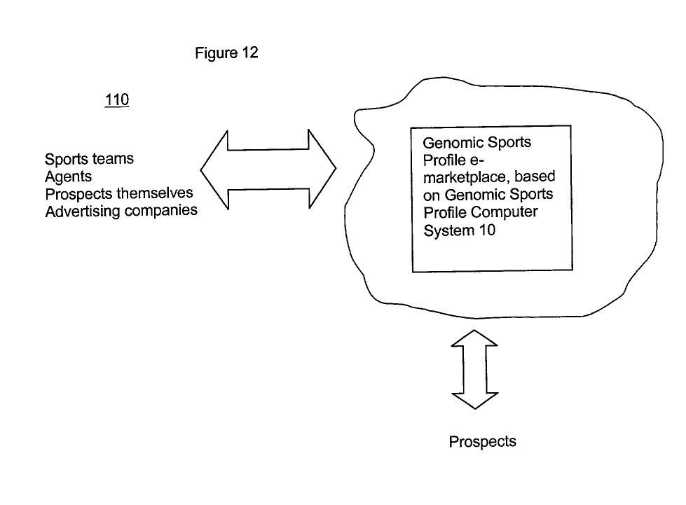

The Genomic Sports Profile e-marketplace 110 is shown in FIG. 12. Use of the Genomic Sports Profile e-marketplace 110 of the present invention is not limited to sports teams and prospects, but could also be used by sports agents, sports marketing companies, re-marketers, qualifying agencies, and other third parties.

FIG. 12 shows an example of a Genomic Sports Profile e-marketplace 110 of the present invention. In the Genomic Sports Profile e-marketplace 110 shown in FIG. 12, buyers (such as sports teams, agents, prospects themselves, advertising companies) are matched with sellers (such as the prospects) of genomic information that includes the above-mentioned rankings and correlation scores of the prospects.

The Genomic Sports Profile e-marketplace 110 may be implemented in a variety of ways, including being particular to all positions in all sports, all positions in one sport, all sports at one level, one sport at one level, one position in one sport at one level.

Testing, Customization, and Rollout

Validation of the present invention could be performed using one sports team and the prospects who have made the team and performed at the level required by the team to remain on the roster for a number of years. That is, the present invention can be validated, and modified as required, to provide fruitful analysis for each team, sport, and position, based upon requirements set forth by each team.

Testing

Testing of the present invention would include the establishment and validation of a proof of product data base (as is known in the art) directed to identifying which genomic sequences are common to pitchers on baseball teams, and which genomic sequences are absent from those pitchers. Establishment of a Genomic Sports Profile data base/scoreboard 16 ranking pitchers currently playing in the minor leagues based on the correlation between their, respective genomic sequences and the identified genomic sequences would then ensue.

Customization

The present invention is customizable to different sports. For example, the present invention can be customized to focus on sports teams involved with baseball, and, more specifically, target a baseball team to determine the genetic profile of each member of its pitching staff to determine what genomic sequences (both positive and negative) are common to all members of the pitching staff. The present invention would, based thereon, establish a Genomic Sports Profile data base/scoreboard 16 of the genomic information collected and analyzed.

Rollout

Establishment of a proof of concept Genomic Sports Profile data base/scoreboard 16 of the present invention would involve one category of champions, for example, the pitching staff of a baseball team.

The present invention would then be implemented by staging the establishment of genetic data bases corresponding to every position in every major, professional sport, including baseball, football, basketball, hockey, soccer, tennis, golf, etc.. A Genomic Sports Profile data base/scoreboard 16 of potential, professional individuals in each of the above-mentioned sports could also be established and tested against actual success and failure.

Utility and Industrial Applicability

Thus, the present invention would provide an additional measure by which prospects are judged for entry into professional sports, and could be used in conjunction with known ways to predict the success of prospects in sports.

In the United States, there are a number of professional team sports, including football, baseball, basketball, hockey, and soccer, totaling more than 100 teams. Moreover, golf and tennis are major professional sports. There are a large number of professional and high-level amateur (such as Olympic, major college, and national) sports teams in the U.S. and worldwide, providing for ready applications for the present invention either in a local area, nationwide, or worldwide.

To sports teams, use of the Genomic Sports Profile data base/scoreboard 16 of the present invention is beneficial because the sports teams save time, effort, and money by investing only in prospects who are likely to succeed in sports. Sports teams also identify, using the Genomic Sports Profile data base/scoreboard 16, prospects whose championship qualities may not have expressed themselves (that is, may not have been included in or apparent from the phenotype) at the time of evaluation of the prospect by conventional means. Thus, sports teams can uncover the so-called “sleepers” or “sleeper individuals” (that is, individuals who may not demonstrate much ability but who have it “in their genes” and who must work to develop their ability), and eliminate prospects who have already “peaked” at their current level (high school or minor league) using the Genomic Sports Profile data base/scoreboard 16 of the present invention. In addition, the present invention provides additional data which a sports team can use to evaluate a prospect, without discounting the use of traditional information including the drive and desire of the prospect.

In addition, use of the Genomic Sports Profile data base/scoreboard 16 of the present invention would be advantageous for each sports team because the sports team would save time, effort, and money which the sports team would have invested in attempted to develop a prospect having no real potential to progress beyond the point which brought him/her to being evaluated by the sports team.

The Genomic Sports Profile data base/scoreboard 16 of the present invention also identifies prospects which would otherwise become members of other teams because their potential is missed by the sports team evaluating the prospect.

To prospects, the use of the Genomic Sports Profile data base/scoreboard 16 is beneficial because the correlation score provide by the present invention would be helpful in establishing the prospect as a legitimate prospect. That is, the prospect may not appear to be a legitimate prospect (that is, may be a so-called “sleeper”) but may have the genetic potential to become a champion. Without the Genomic Sports Profile data base/scoreboard 16, the prospect may never get the opportunity to be developed by a sports team. In addition, the Genomic Sports Profile data base/scoreboard 16 provides the prospect with another measure of potential success, without concern that the prospect may not have played up to potential during traditional evaluation workouts.

Moreover, use of the Genomic Sports Profile data base/scoreboard 16 of the present invention would be beneficial to each prospect to provide additional data to realistic assess the prospect's chances for success in a given endeavor.

Evaluation by the Genomic Sports Profile data base/scoreboard 16 of the present invention provides a prospect with information about his/her real potential to progress to the next level of sport, and thus provides a basis for the prospect to determine whether continued pursuit of the next level is realistic.

Advantageously, the present invention provides comparisons between prospects and other, current prospects and prior prospects at the genomic level, the most basic analysis available. Moreover, once algorithms and software of the present invention are developed, each is customizable or is reusable with little or no modifications. In addition, the algorithms and software of the present invention would be portable across sports, professions, and trades, providing an ease of expansion into many professions. Moreover, evaluations of prospects would provide a competitive edge to prospects and teams using the present invention. In addition, the Genomic Sports Profile e-marketplace 110 would provide a medium by which sports teams and prospects could be brought together. In addition, the present invention can be used successfully by even a single team.

Moreover, the present invention provides privacy associated with genomic data analysis and collection of baseline genomic data from champions, a methodology for updating the Genomic Sports Profile data base/scoreboard 16 on either a regular basis or an ad hoc basis, and a methodology and use for evaluations based upon genomic information.

Access to the present invention would be beneficial to prospective employers (such as professional teams) and to individuals interested in determining how closely they correlate genetically with the recognized champions (“the best”).

In addition, the present invention may be applied to all sports, even those considered to be individual sports, and applied to individuals wanting to gauge their potential for success in many different sports. Further, the present invention can be applied to endeavors including software developers, consultants, CEOs, medical students, sales, entrepreneurship, banking, and other endeavors.

Moreover, the present invention is not limited to sports involving humans mentioned above, but may also be applied to other sports involving humans and sports involving other animals (such as dogs (dog racing), horses (thoroughbred horseracing), fish, birds, cats (cat shows), cows, etc.). The present invention may also include combinations of individuals participating in individual sports, on the same team or on opposing teams.

The many features and advantages of the invention are apparent from the detailed specification and, thus, it is intended by the appended claims to cover all such features and advantages of the invention that fall within the true spirit and scope of the invention. Further, since numerous modifications and changes will readily occur to those skilled in the art, it is not desired to limit the invention to the exact construction and operation illustrated and described, and accordingly all suitable modifications and equivalents may be resorted to, falling within the scope of the invention.

What is claimed is:

1. A computer system comparing genomic sequences of prospects to evaluate potential for success in sports of individuals, comprising:
a data base storing genomic sequences of prospects and a scoreboard, the scoreboard including rankings and correlation scores of a current prospect based upon comparisons between the genomic sequences of the current prospect with the genomic sequences of prior prospects; and
a data base populating module populating the data base by determining the correlation scores and the rankings based upon correlation between the genomic sequences of the current prospect with the genomic sequences of the prior prospects.

2. The computer system of claim 1, further comprising a software evaluation results display module formatting and displaying the correlation.

3. The computer system of claim 2, wherein the data base populating module comprises:
a sport/position categorization decision module categorizing the input genomic sequences by sport and position;
an evaluation module establishing a first correlation score of the current prospect with champions based upon the genomic sequences, establishing a second correlation score of the current prospect with the unsuccessful prospects based upon the genomic sequences, establishing an overall correlation score of the current prospect based upon the first correlation score and the second correlation score; and
a scoreboard populating module populating the scoreboard and establishing the rank of the current prospect based upon the overall correlation score for each of the prospects.

4. The computer system of claim 3, wherein the evaluation module is updated based upon additional genomic sequences input.

5. The computer system of claim 2, wherein the software evaluation results display module comprises:
a security evaluation module determining whether a user is allowed to access the information;
a data base retrieval module retrieving the name, rank, and correlation scores corresponding to each current prospect based upon position and sport;
a scoreboard validation/additional analysis module revising the rank and correlation scores based upon additional input information; and
a display mode selection module formatting and displaying the names, ranks, and correlation scores of the current prospects.

6. A display of a computer system, comprising:
names of current prospects grouped by sport and position; and
ranks and correlation scores of the current prospects based upon correlation of genomic sequences of the current prospects with genomic sequences of prior prospects, said ranks and correlation scores indicating potential for success in sports of individuals.

7. The display of claim 6, further comprising:
the correlation scores of the current prospects based upon correlation of the genomic sequences of the current prospects with champions and correlation of the genomic sequences of the current prospects with unsuccessful prospects.

8. The display of claim 6, further comprising:
ranks of the current prospects in the sport.

9. A genomic sports profile e-marketplace matching individuals with sports teams, based upon rankings and correlation scores of individuals based upon comparisons between genomic sequences and comprising:
a computer system evaluating the potential for success in sports of the individuals, said computer system in communication with the individuals and sports teams and providing information to the sports teams based upon correlation scores and ranks of the individuals based upon correlations of genomic sequences of the individuals with genomic sequences of prior prospects.

10. The genomic sports profile e-marketplace of claim 9, wherein the individuals comprise current prospects.

11. A method of evaluating potential for success in sports of individuals, comprising:
determining correlation scores of the individuals with prior prospects based upon correlation between genomic sequences of the individuals and genomic sequences of prior prospects; and
ranking the individuals based on the correlation.

12. The method of claim 11, further comprising:
determining correlations between genomic sequences of the individuals and genomic sequences of champions.

13. The method of claim 11, further comprising:
determining correlations between genomic sequences of the individuals and genomic sequences of unsuccessful prospects.

14. The method of claim 11, further comprising:
determining correlations between genomic sequences of the individuals and genomic sequences of champions, and
determining correlations between genomic sequences of the individuals and genomic sequences of unsuccessful prospects.

15. The method of claim 11, further comprising:
ranking the individuals by sport.

16. The method of claim 15, further comprising:
ranking the individuals by position.

17. A computer-readable medium storing a program which, when executed by a computer, causes the computer to evaluate potential for success in sports of individuals by executing the processes comprising:
determining correlation scores and rankings of the individuals by determining correlation between genomic sequences of the individuals and genomic sequences of prior prospects; and
ranking the individuals based on the correlation.

18. The medium of claim 17, further comprising:
determining correlations between genomic sequences of the individuals and genomic sequences of champions.

19. The medium of claim 17, further comprising:
determining correlations between genomic sequences of the individuals and genomic sequences of unsuccessful prospects.

20. The medium of claim 17, further comprising:
determining correlations between genomic sequences of the individuals and genomic sequences of champions, and
determining correlations between genomic sequences of the individuals and genomic sequences of unsuccessful prospects.

21. The medium of claim 17, further comprising:
ranking the individuals by sport.

22. The medium of claim 20, further comprising:
ranking the individuals prospects by position.
